(19) United States
(12) Patent Application Publication
(10) Pub. No.: US 2014/0247599 A1
(43) Pub. Date: Sep. 4, 2014

(54) Lighting Assembly

(71) Applicant: Gary D. Yurich, Royal Oak, MI (US)

(72) Inventor: Gary D. Yurich, Royal Oak, MI (US)

(21) Appl. No.: 14/279,811

(22) Filed: May 16, 2014

Related U.S. Application Data
(63) Continuation-in-part of application No. 13/434,530, filed on Mar. 29, 2012.
Application No. 13/434,530 is a continuation-in-part of application No. 12/684,524, filed on Jan. 8, 2010, now Pat. No. 8,641,239.

(51) Int. Cl. F21V 7/04; F21K 99/00

(52) U.S. Cl. CPC F21V 7/04; F21K 9/50
USPC 362/304

(57) ABSTRACT

A lighting assembly for illuminating an area is disclosed. The lighting assembly includes a reflective body. The reflective body includes a first array of reflectors that are disposed about a central axis. The reflectors collectively form a dome-shaped configuration. Each reflector defines a lower end and an opposing upper end. Each reflector comprises a plurality of planar surfaces. The planar surfaces are defined between the lower end and the upper end. The planar surfaces are separated from one another by discrete horizontal bends. The planar surfaces collectively form an arcuate configuration between the lower end and the upper end. At least two reflectors each define an opening between the lower and upper ends. An LED assembly is disposed adjacent each one of the openings such that the reflective body reflects light emitted from the LED assemblies.

### RELATED APPLICATIONS

This application is a continuation-in-part application of U.S. patent application Ser. No. 13/434,530 entitled LIGHTING ASSEMBLY, filed on Mar. 29, 2012, which is a continuation-in-part application of U.S. patent application Ser. No. 12/684,524 for a REFLECTOR FOR A LIGHTING ASSEMBLY, filed on Jan. 8, 2010, both of which are hereby incorporated by reference in their entirety.

### FIELD OF THE INVENTION

The present invention generally relates to a lighting assembly, and more specifically, a lighting assembly having a reflective body for dispersing light.

### BACKGROUND

Lighting assemblies that utilize reflectors are well known in the art. Such lighting assemblies are used for a variety of purposes, such as illuminating indoor facilities. Such prior art lighting assemblies conventionally utilize light sources such as high intensity discharge (HID) lamps, and the like. Such light sources are commonly utilized because of their ability to emit light in all directions.

However, such light sources can be inefficient and consume much energy. Additionally, such light sources often require a warm-up period before reaching full intensity. The intensity of such light sources can also be difficult to manipulate. Moreover, such light sources often require frequent maintenance and replacement. Consequently, such light sources are expensive to operate.

Other conventional light assemblies have attempted to utilize LEDs as a light source. Unlike light sources such as HID lamps, LEDs consume dramatically less energy, instantly reach full intensity, are fully dimmable, and are much less expensive to maintain and operate. However, unlike other light sources which emit light in all directions, LEDs emit light in limited directions.

In attempt to uniformly reflect the light from the LEDs, some prior art light assemblies utilize complex components, optics and circuitry. Other prior art light assemblies having dome-shaped reflectors, go no further than disposing the LEDs at a hole defined at an apex of the reflective dome. However, such configuration fails to provide uniform reflection of the LED light because much of the LED light directly exits the light assembly without being reflected. Additionally, prior art light assemblies face challenges in managing the heat generated by the LEDs during operation.

As such, there remains a need for a lighting assembly that is cost-effective, simple in construction, and that uniformly reflects light emitted from the LEDs. Additionally, there remains a need for a lighting assembly that provides solutions to managing heat emitted by the LEDs.

### SUMMARY OF THE INVENTION

The present invention provides a lighting assembly for illuminating an area. The lighting assembly includes a reflective body. The reflective body includes a first array of reflectors that are disposed about a central axis. The reflectors collectively form a dome-shaped configuration. Each reflector defines a lower end and an opposing upper end. Each reflector comprises a plurality of planar surfaces. The planar surfaces are defined between the lower end and the upper end. The planar surfaces are separated from one another by discrete horizontal bends. The planar surfaces collectively form an arcuate configuration between the lower end and the upper end. At least two reflectors each define an opening between the lower and upper ends. An LED assembly is disposed adjacent each one of the openings such that the reflective body reflects light emitted from the LED assemblies.

By utilizing the LED assemblies, the lighting assembly consumes dramatically less energy, instantly reaches full intensity, is fully dimmable, and is much less expensive to maintain and operate. Meanwhile, the lighting assembly advantageously provides uniform reflection of the light emitted from the LED assemblies. Mainly, the openings are defined between the upper and lower ends of the reflectors to provide optimal positioning of the LED assemblies. By being disposed adjacent such openings, the light emitted from the LED assemblies is effectively reflected by the planar surfaces of the reflective body. The planar surfaces are oriented with respect to the LED assemblies to provide optimized combinations of angles to evenly reflect the light emitted by the LED assemblies and provide an improved glow. Also, disposing the LED assemblies adjacent the openings provides a cost-effective solution to the problems associated with LED light directionality.

Furthermore, the installation of the lighting assembly is not complex. This is desirable because facilities typically require numerous assemblies. Additionally, the lighting assembly does not require specialized wiring thereby saving the cost of an electrician or a specialized technician. The lighting assembly need only be plugged into a standard electrical outlet.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an environmental view of a plurality of lighting assemblies, suspended from a ceiling, of the present invention.

FIG. 2 is a perspective view of a lighting assembly of the present invention.

FIG. 3 is a partially cross-sectional perspective view of the lighting assembly.

FIG. 4 is a partially exploded view of the lighting assembly.

FIG. 5 is an end view of the lighting assembly.

FIG. 6 is a perspective view of a reflective body of the lighting assembly.

FIG. 7 is planar view of a first reflector.

FIG. 8 is a planar view of an upper panel.

FIG. 9 is a perspective view of the first reflector.

FIG. 10 is a perspective view of the upper panel.

FIG. 11 is a fragmented perspective view of the reflective body.

FIG. 12 is a top view of the reflective body.

FIG. 13 is a fragmented enlarged top view of the reflective body.

FIG. 14 is a fragmented perspective view of the second reflector illustrating a smooth surface finish.

FIG. 15 is a fragmented perspective view of the second reflector illustrating a first surface treatment.

FIG. 16 is a fragmented perspective view of the second reflector illustrating a second surface treatment.

FIG. 17 is a perspective view of a lighting assembly of another embodiment.

FIG. 18 is a perspective view of a lighting assembly of another embodiment utilizing a bracket and a ballast coupled to the bracket.

FIG. 19 is perspective of a lighting assembly of another embodiment utilizing a bracket and a ballast coupled to the bracket

FIG. 20 is a partially broken perspective view of a lighting assembly having a pair of sockets for accepting a pair of light sources.

FIG. 21 is a partially broken perspective view of another embodiment of the lighting assembly having three sockets for accepting three light sources.

FIG. 22 is a perspective view of an LED assembly according to one embodiment.

FIG. 23 is a top perspective view of the reflective body and a plurality of LED assemblies disposed adjacent the reflective body according to one embodiment.

FIG. 24 is a top view of the reflective body and the LED assemblies disposed adjacent the reflective body according to another embodiment.

FIG. 25 is a top view of the reflective body and the LED assemblies disposed adjacent the reflective body according to yet another embodiment.

FIG. 26 is a top view of the reflective body and the LED assemblies disposed adjacent the reflective body according to yet another embodiment.

FIG. 27 is a perspective view of adjacent first reflectors and the LED assembly according to one embodiment.

FIG. 28 is a left side view of one of the first reflectors and the LED assembly of FIG. 27.

FIG. 29 is a perspective view of a plurality of LED assemblies disposed adjacent to one first reflector according to one embodiment.

FIG. 30 is a left side view of the plurality of LED assemblies and the first reflector of FIG. 29.

FIG. 31 is a perspective view of the first reflector and the LED assembly according to another embodiment.

FIG. 32 is a left side view of the first reflector and the LED assembly of FIG. 31.

FIG. 33 is a partially cross-sectional perspective view of the lighting assembly according to another embodiment.

### DETAILED DESCRIPTION OF THE INVENTION

Referring to the Figures wherein like numerals indicate like or corresponding parts throughout the several views, a lighting assembly is generally shown at 20.

The lighting assembly 20 provides light to illuminate an area. In one embodiment, the lighting assembly 20 provides light for a facility, such as an arena, a practice field, a pool area, and the like.

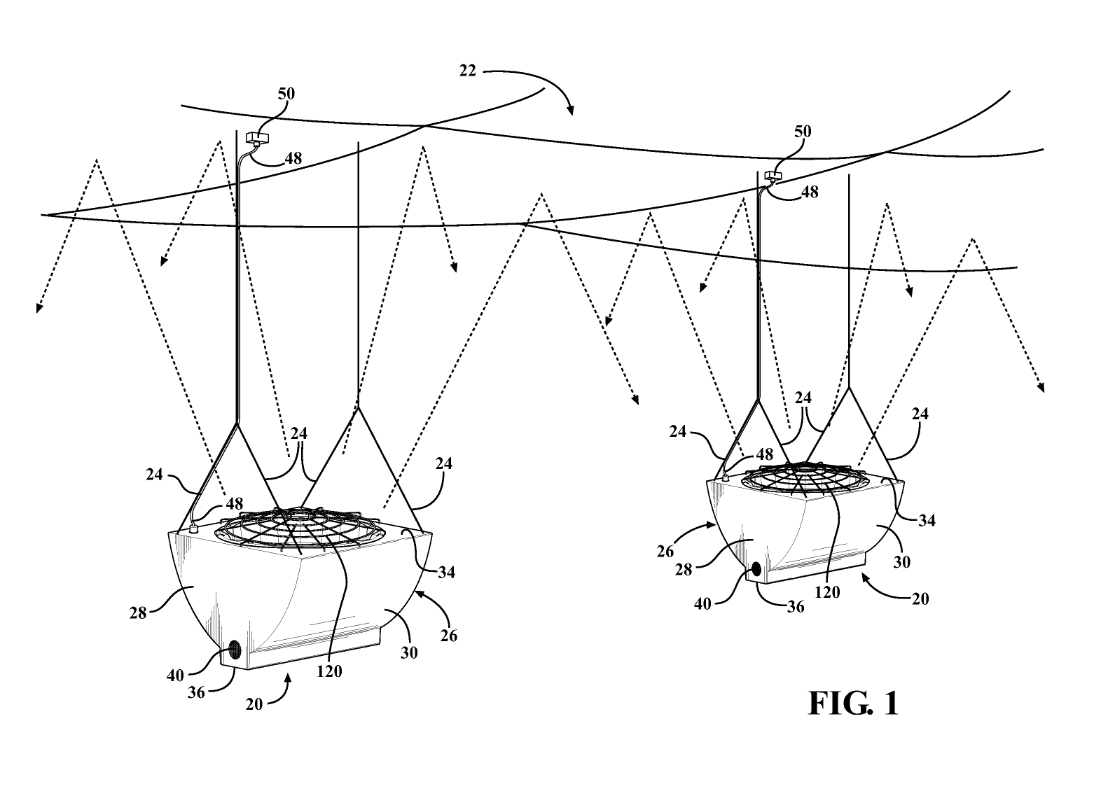

The lighting assembly 20 may be mounted according to various configurations. As shown in FIG. 1, the lighting assembly 20 may be suspended from a ceiling 22 of the facility. The lighting assembly 20 is typically coupled to the ceiling 22 utilizing an attachment mechanism 24. The attachment mechanism 24 may comprise a plurality of cables 24 for suspending the lighting assembly 20 from the ceiling 22. However it should be appreciated that the attachment mechanism 24 may comprise any suitable method of coupling the lighting assembly 20 to the ceiling 22 without deviating from the scope of the subject invention.

In one embodiment, the lighting assembly 20 operates as an indirect-light assembly. In such instances, the lighting assembly 20 illuminates the ceiling 22 thereby providing indirect light to an area below the lighting assembly 20. For illustrative purposes, light rays are shown with dashed lines in FIG. 1.

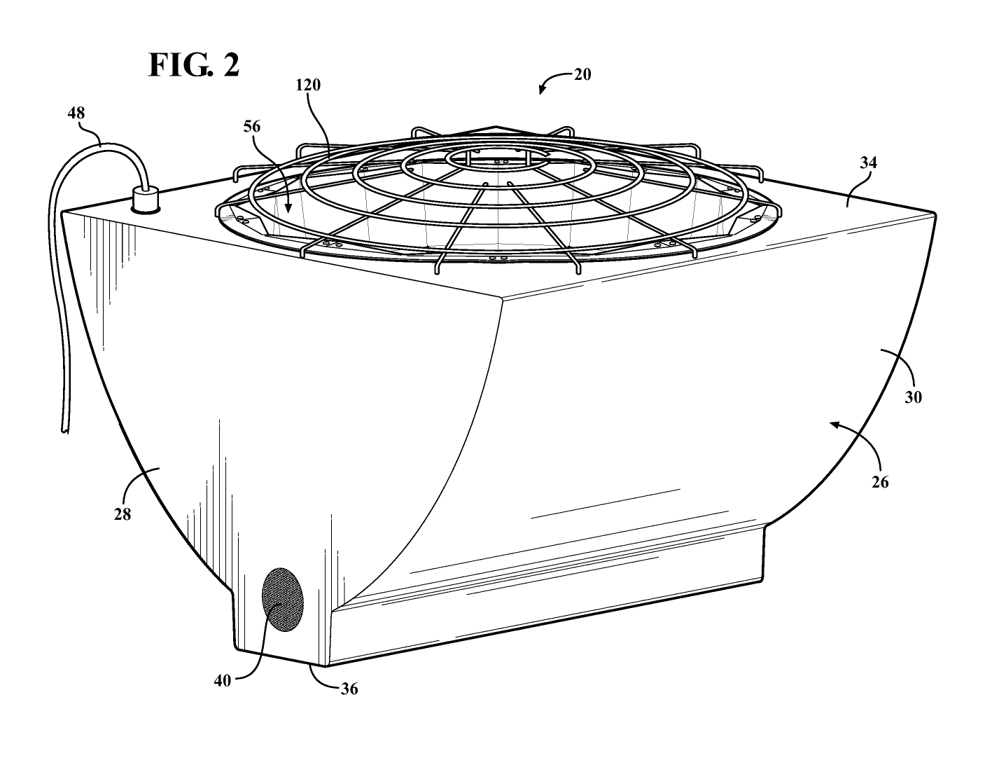

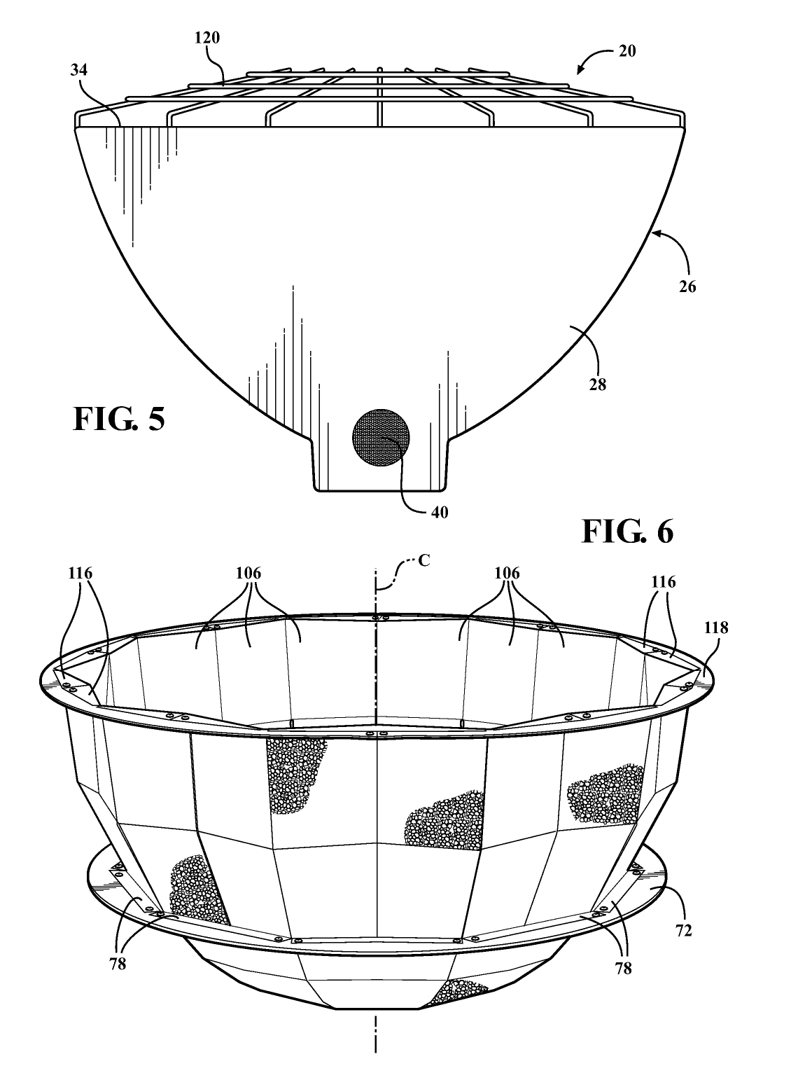

The lighting assembly 20 may include a housing 26. In one embodiment, as shown in FIGS. 2-5, the housing 26 comprises a pair of end walls 28 spaced from and substantially parallel to one another. The housing 26 may further include a pair of side walls 30 disposed between and substantially perpendicular to the end walls 28. The side walls 30 and the end walls 28 define a cavity 32 therebetween. A top wall 34 and a bottom wall 36 typically bound the end walls 28 and the side walls 30 and enclose the cavity 32. The top wall 34 defines an aperture 38 for allowing access into the cavity 32. The end walls 28 may define at least one vent 40 for allowing air to enter into and exit out of the cavity 32 to ventilate the cavity 32.

In one embodiment, the housing 26 may be integrally formed as a single integrally formed unit. The housing 26 may be integrally formed according to various methods. In one embodiment, the housing 26 is integrally formed by die-casting. The housing 26 may be formed of any suitable material, such as metal, and the like.

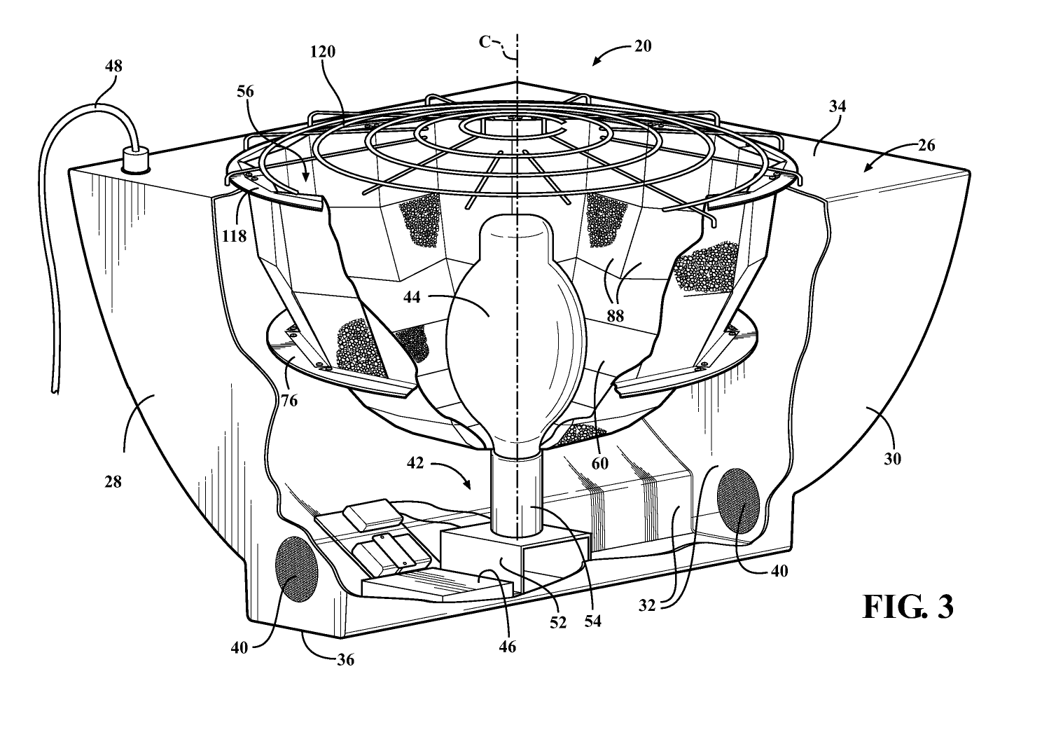

As shown in FIG. 3, the lighting assembly 20 includes an electrical system 42. The electrical system may be disposed within the cavity 32. In one example, the electrical system 42 includes a light source 44 and a ballast 46 coupled to the light source 44 for regulating electricity supplied to the light source 44.

A power cable 48 is disposed through the housing 26 for coupling the electrical system 42 to an electric power source 50 and supplying electricity thereto. Typically, the electric power source 50 is a standard electrical outlet, also known in the art as a receptacle. However, any appropriate electric power source 50 may be utilized. In some embodiments, the lighting assembly 20 may also be directly wired to the power source 50, generally known in the art as hard wired, without deviating from the scope of the present invention. Additionally, it should be appreciated that alternative types of ballasts yet or power supplies or AC/DC converters will be required based on the type of light source chosen and will not deviate from the subject invention.

In FIG. 3, the light source 44 is a metal halide lamp. For such types of lamps, a pulse-start ballast is typically used. The light assembly 20 may utilize other types of light sources, such as metal-halide, high-pressure sodium, mercury vapor, plasma light, gas-discharge lamp, or any other light source known in the art. In the embodiments as shown in FIGS. 23-33, the light source 44 is an LED assembly. The LED assembly is described in detail below.

In FIG. 3, a lamp stand 52 is secured within the cavity 32 and includes a socket 54. The socket 54 accepts the light source 44 and electrically couples the light source 44 to the ballast 46. Generally, heat generated from the electrical system 42 may be dissipated through the aperture 38. The vents 40 draw in air to keep the light source 44 cool thereby extending the life of the light source 44.

The lighting assembly 20 may further include a screen 120. The screen 120 is typically disposed over the reflective body 56 for protecting the light source 44, as well as the reflective body 56. The screen 120 may be further defined as a wire guard, a glass lens, or any other apparatus configured to cover the light source 44 and/or the reflective body 56, while allowing light to pass therethrough.

With reference to FIGS. 1-5, the screen 120 may be coupled to the top wall 34 of the housing 26. Typically, the screen 120 is removable from the housing 26 for allowing access to the light source 44. The screen 120 may be coupled to the top wall 34 utilizing any appropriate method. As an example, the top wall 34 may define a plurality of holes and the screen 120 may be configured to mate with the holes in the top wall 34 for securing the screen 120 thereon. Alternatively, the screen 120 may be configured to fit within the aperture 38 defined by the top wall 34 such that the screen 120 is retained over the reflective body 56 through a tension created between the housing 26 and the screen 120. In other alternatives the screen 120 may be coupled to the top wall 34 utilizing fasteners such as clips, clasps, latches, or any other appropriate fastener.

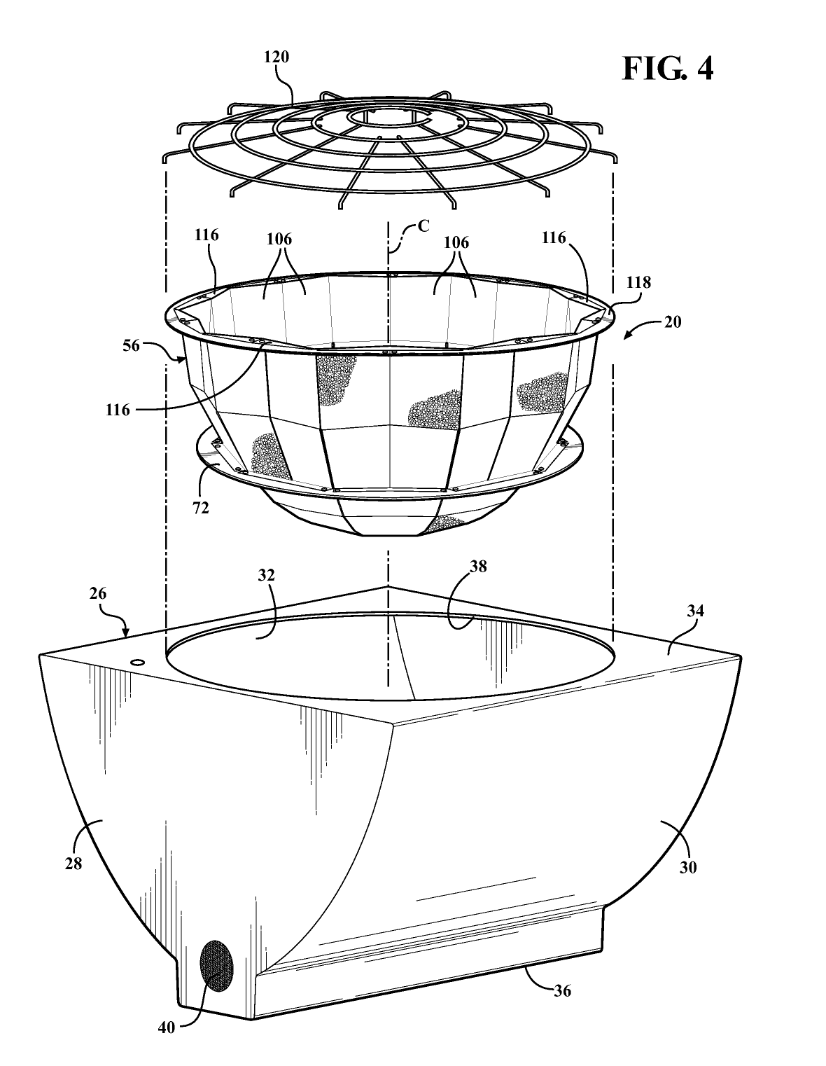

The lighting assembly 20 further includes a reflective body 56. The reflective body 56 generally defines a dome-shaped configuration. The reflective body 56 may be disposed within and secured to the housing 26. In FIG. 4, the reflective body 56 is disposed in the aperture 38 defined by the top wall 34. Alternatively, the reflective body 56 may be utilized without the housing 26.

In FIG. 3, the light source 44 extends through the reflective body 56 and defines a central axis C. The lamp stand 52 positions the light source 44 relative to the reflective body 56 for directing the light. In one embodiment, the metal halide lamp includes an arc tube (not shown) that emits light from the lamp. The location of arc tube relative to the reflective body 56 determines the output from the lighting assembly 20. In practice, the light output from the lighting assembly 20 can vary by up to 40% based on the location of the lamp stand 52. It is to be appreciated that the optimal location of the light source 44 will be dictated by the type of light source 44 used with the lighting assembly 20. The light emitted from the light source 44 is reflected off of the reflective body 56 and uniformly dispersed out of the lighting assembly 20 for providing uniform illumination to an area below the lighting assembly 20. The lighting assembly 20 of the present invention is able to emit up to 93% of the light provided by the light source 44.

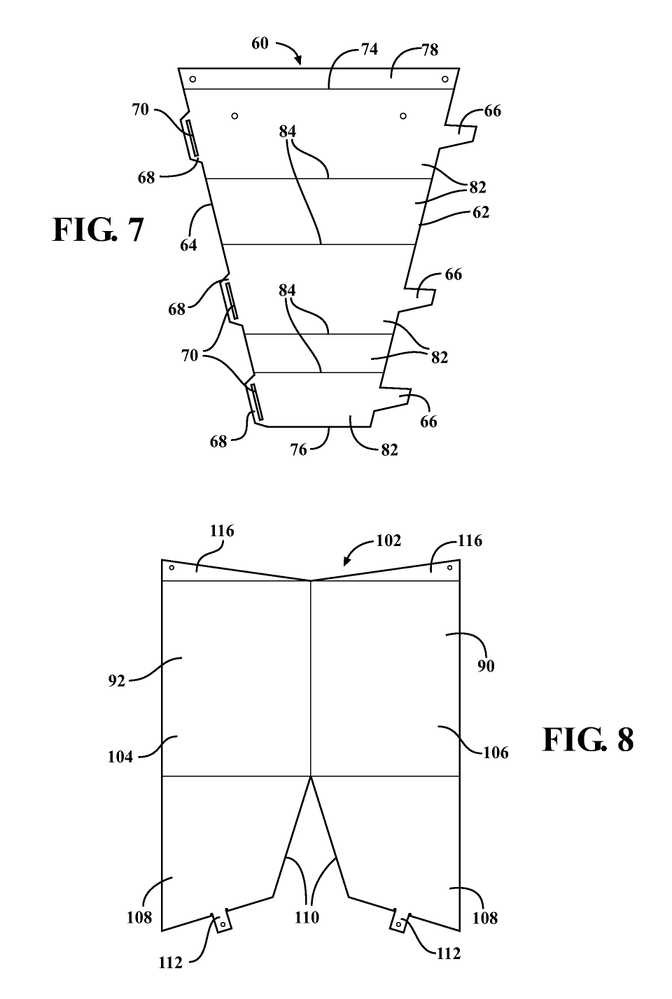

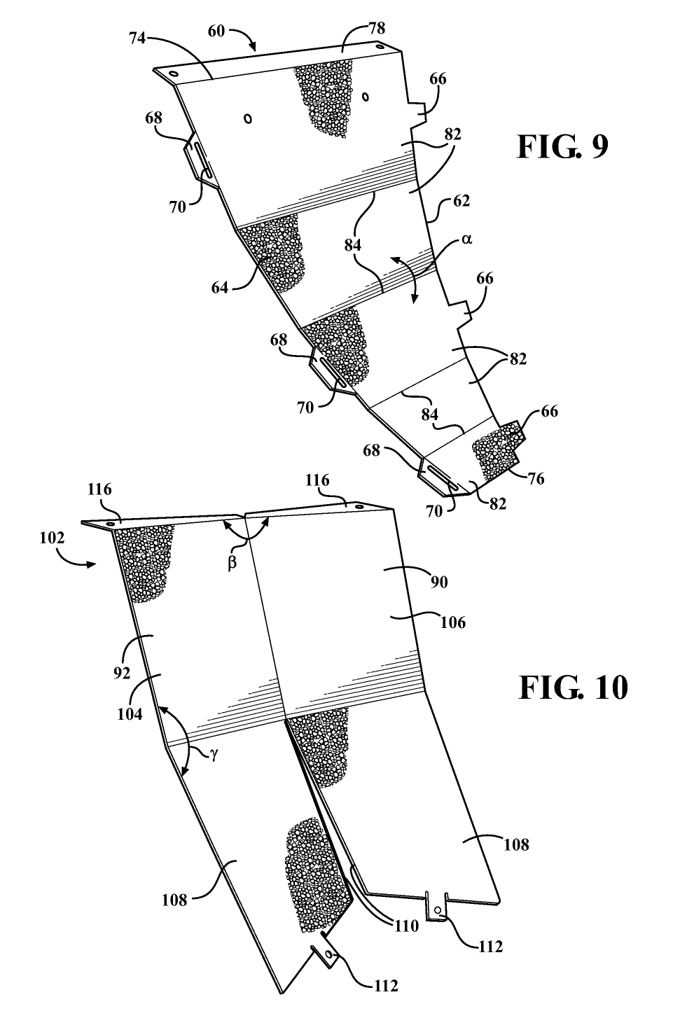

The reflective body 56 includes a plurality of first reflectors 60 disposed adjacent one another. FIG. 7 shows the first reflector 60 in a planar view prior to being formed. FIG. 9 illustrates the first reflector 60 in a perspective view after the first reflector 60 has been formed.

The first reflector 60 includes a first side 62 and a second side 64. A plurality of first attachment elements 66 may extend from the first side 62. The first attachment elements 66 are further defined as tabs 66. A plurality of second attachment elements 68 may extend from the second side 64 and define a slot 70. Each slot 70 is adapted to accept one of the tabs 66 extending from the next adjacent first reflectors 60 for securing the first reflectors 60. It is to be appreciated that other methods of attaching the first reflectors 60 together may be employed without deviating from the subject invention.

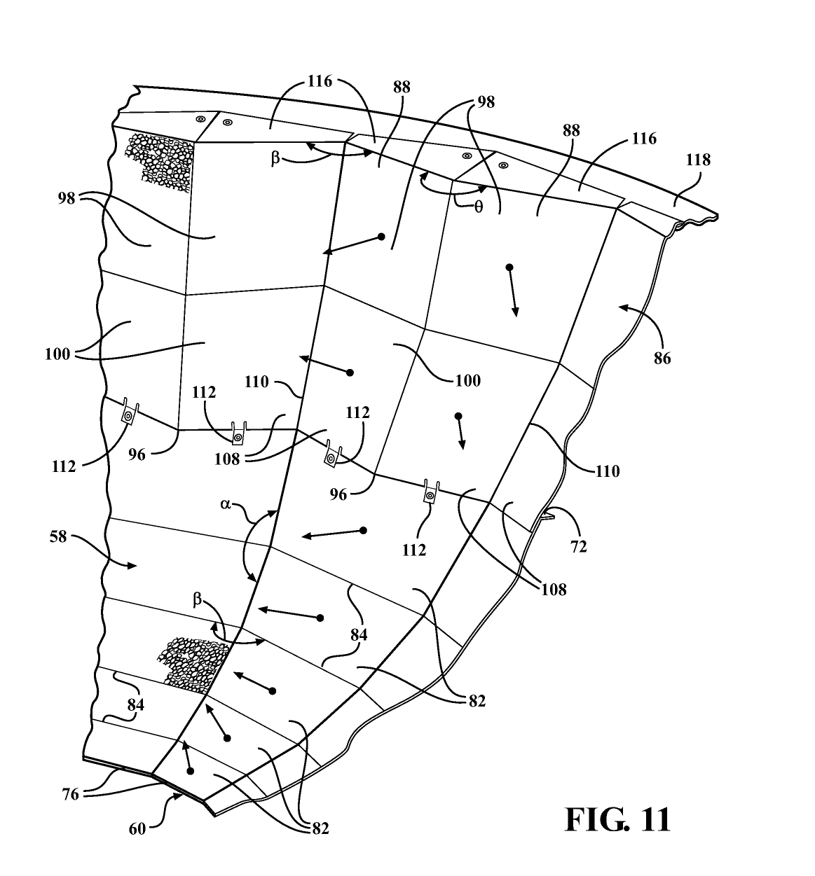

As shown in FIG. 11, the adjacent first reflectors 60 form a first array 58. Each of the first reflectors 60 are in an obtuse angular relationship with the next adjacent first reflectors 60. As a result of the obtuse angular relationships, the first reflectors 60 collectively form a dome-shaped configuration. For illustrative purposes only, this obtuse angular relationship is illustrated as β. Typically β is of from about 110° to about 170°, more typically from about 120° to about 150°.

In one embodiment, as shown in FIG. 23, the reflective body 56 includes the first array 58. In other embodiments, as shown in FIGS. 11, 12, and 24-26, the reflective body 56 includes the first array 58 and a second array 86. In such instances, the first array 58 may be defined as a lower array 58 and the second array 86 may be defined as an upper array 86. Thus, the terms “lower array” and “first array” as used herein are interchangeable. Similarly, the terms “upper array” and “second array” as used herein are interchangeable. The second array 86 is described in detail below.

As best shown in FIG. 6, a lower ring 72 may be disposed about the central axis C. The first reflectors 60 further include a first upper end 74 and a lower end 76 spaced from and opposite the first upper end 74. A first flange 78 may extend from the first upper end 74 for attaching to the lower ring 72 and securing the first reflectors 60 in the lower array 58.

It is to be appreciated that the terms “upper” and “lower” as used herein to describe the arrays or the ends of the reflector are not intended to limit the orientation of such features. In other words, the reflective body 56 may be oriented such that the lower array 58 is physically oriented above the upper array 86. Similarly, the upper end 74 of the first reflector 60 may be physically oriented below the lower end 76. This is particularly true in instances where the lighting assembly 20 is utilized in direct light applications as opposed to indirect light applications.

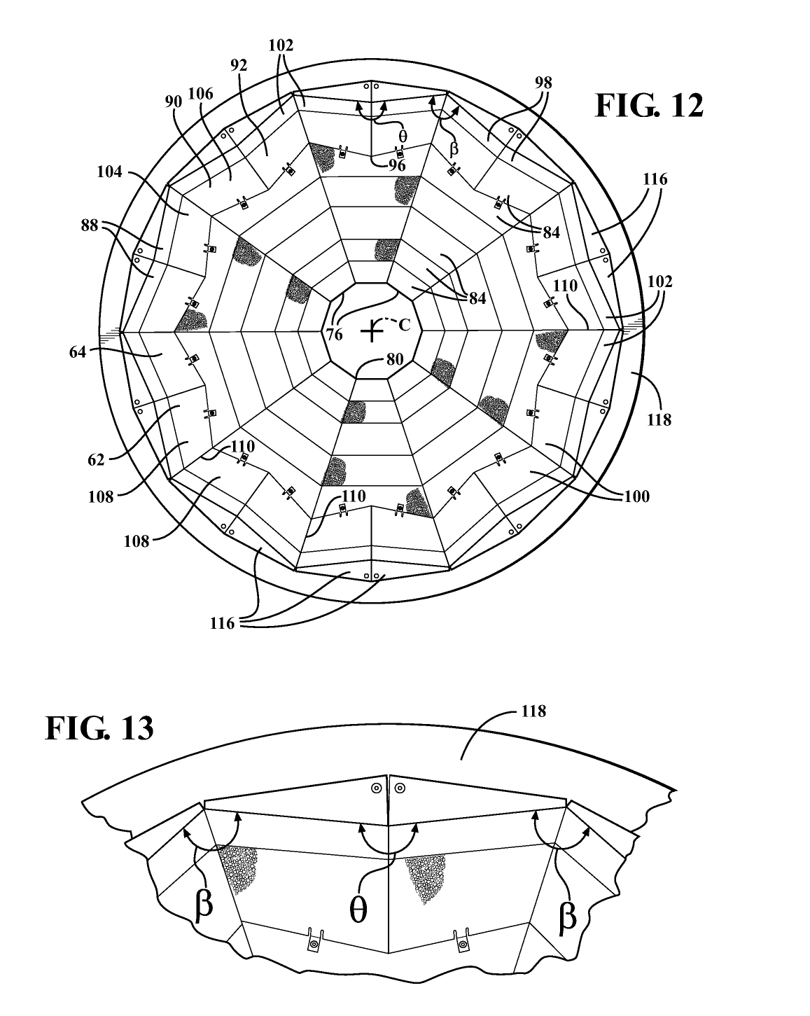

In one embodiment as shown in FIG. 12, the lower end 76 of each of the first reflectors 60 defines a hole 80. The hole 80 is defined collectively between the lower ends 76 of the first reflectors 60. In such embodiment, the hole 80 is provided for allowing the light socket 54 and the light source 44 to pass therethrough and into the reflective body 56.

Alternatively, as shown in FIG. 23-26, the reflective body 56 may have no need for the hole 80. As will be described in detail below, the light source 44 may be disposed at locations other than the hole 80. In such instances, the hole 80 may be eliminated according to various methods. In one example, the reflective body 56 may include a cap 81 for covering the hole 80. The cap 81 may attach to the first reflectors 60 according to any suitable method. The cap 81 may be coupled to the lower ends 76 of the first reflectors 60. The cap 81 may have any configuration, such as a planar configuration or a parabolic configuration. In another embodiment, the lower ends 76 of the first reflectors 60 may converge or join together thereby sealing the hole 80. Alternatively, the reflective body 56 may be integrally formed as a single piece such that no hole 80 is formed.

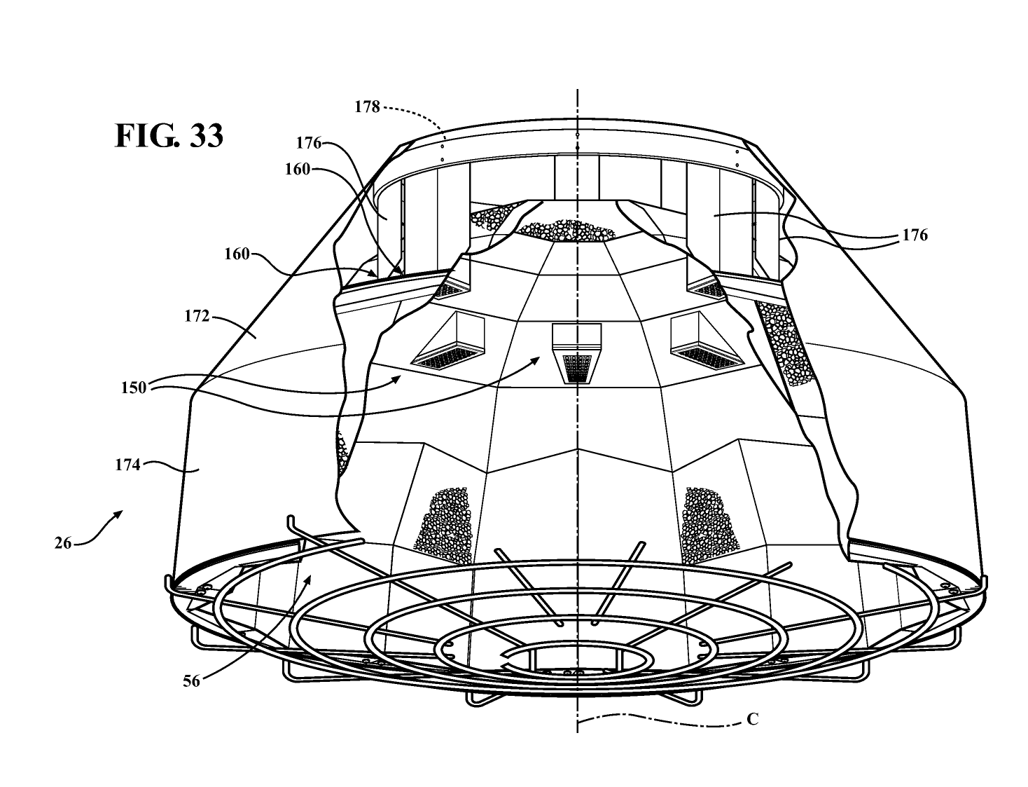

In instances where the hole 80 is not present, the central axis C may be alternatively defined. In one instance, the central axis C is defined through a center of the cap 81, as shown in FIG. 33. Alternatively, the central axis C may be defined through a virtual geometric center of the reflective body 56.

Each of the first reflectors 60 comprises a plurality of planar surfaces 82. The planar surfaces 82 are defined between the upper end 74 and the lower end 76 of each first reflector 60. The planar surfaces 82 are defined by a plurality of horizontal bends 84. The horizontal bends 84 also separate the planar surfaces 82 from one another. The term “bend” as used herein is not limited to the mechanical act of bending the planar surfaces 82. For example, the planar surfaces 82 may be integrally cast with horizontal bends 84 such that mechanical bending is not required.

Each of the planar surfaces 82 are in an obtuse angular relationship with each of the next adjacent planar surfaces 82. For illustrative purposes only, this obtuse angular relationship is illustrated as α in FIG. 11. It is to be appreciated that the obtuse angular relationship α between each of the planar surfaces 82 may vary along the first reflector 60. Said differently, each of the planar surfaces 82 are at different obtuse angles relative to one another. The obtuse angles between the planar surfaces 82 progressively get steeper moving from the lower end 76 toward the first upper end 74 along each of the first reflectors 60, such that an arcuate configuration is formed, as best shown in FIG. 9. Additionally, each of the planar surfaces 82 increase in size moving from the lower end 76 toward the first upper end 74. As a result of the obtuse angular relationship between adjacent planar surfaces 82, the planar surfaces 84 collectively form an arcuate configuration between the lower end 76 and the upper end 74, as shown in FIG. 9.

In FIGS. 11-13 and 24-26, the reflective body 56 further includes the upper array 86 of second reflectors 88. The second reflectors 88 are disposed about the central axis C. The second reflectors 88 are coupled to the first reflectors 60, forming the dome-shaped configuration. Each of the second reflectors 88 includes a left face 90 and a right face 92 defining a reflex angle θ therebetween. In one embodiment, θ is greater than 180°. More specifically, θ is defined in a range between 181° and 270°. Alternatively, θ is defined in a range between 181° to 220°.

The reflex angle θ terminates in a vertex 96 forming a triangular protrusion extending toward the central axis C. The vertex 96 is centrally disposed on planar surface of the first reflectors 60 nearest each of the second reflectors 88. The left face 90 and the right face 92 each include an upper portion 98 and a lower portion 100 and define an obtuse angular relationship between the upper portion 98 and the lower portion 100 of each of the left 90 and right 92 faces such that the upper portion 98 is at a steeper incline than the lower portion 100. For illustrative purposes only, this obtuse angular relationship is illustrated as γ in FIG. 10. Additionally, the upper array 86 defines an obtuse angular relationship between next adjacent second reflectors 88, illustrated as β as described above.

FIG. 8 shows an upper panel 102 in a planar view prior to being formed. FIG. 10 illustrates the upper panel 102 in a perspective view after the upper panel 102 has been formed. The upper panel 102 is further defined as a plurality of upper panels 102 and will be referred to in the plural form henceforth.

Each of the second reflectors 88 are formed by a pair of next adjacent upper panels 102. The upper panels 102 include a primary side 104 and a secondary side 106. The primary side 104 forms the right face 92 of one of the second reflectors 88 and the secondary side 106 forms the left face 90 of the next adjacent second reflectors 88. The upper panels 102 include the upper portion 98 of the second reflectors 88 described above.

Additionally, the upper panels 102 include a pair of legs 108 extending from the upper portion 98 and define a slit 110 therebetween for allowing the upper panels 102 to bend forming the second reflectors 88. The legs 108 form the lower portion 100 of the second reflectors 88. Each of the legs 108 may include a projection 112 extending therefrom for fastening to the first reflectors 60. Each of the primary side 104 and the secondary side 106 further include a second upper end 114 each having a second flange 116 extending therefrom.

Referring now to FIGS. 6 and 11, an upper ring 118 may be disposed about the central axis C and spaced from the lower ring 72. Each second flange 116 attaches to the upper ring 118 for securing the upper panels 102 in the upper array 86. In one embodiment, the slit 110 is aligned with the second side 64 of one of first reflectors 60 and the first side 62 of the next adjacent first reflectors 60, such that one of the legs 108 of the upper panels 102 is coupled to one of the first reflectors 60 and the other one of the legs 108 is coupled to the next adjacent first reflectors 60.

In one embodiment, the first 60 and second 88 reflectors are fabricated from Micro-4® aluminum, manufactured by Alanod®. Alternatively, the first 60 and second 88 reflectors may be formed of other materials.

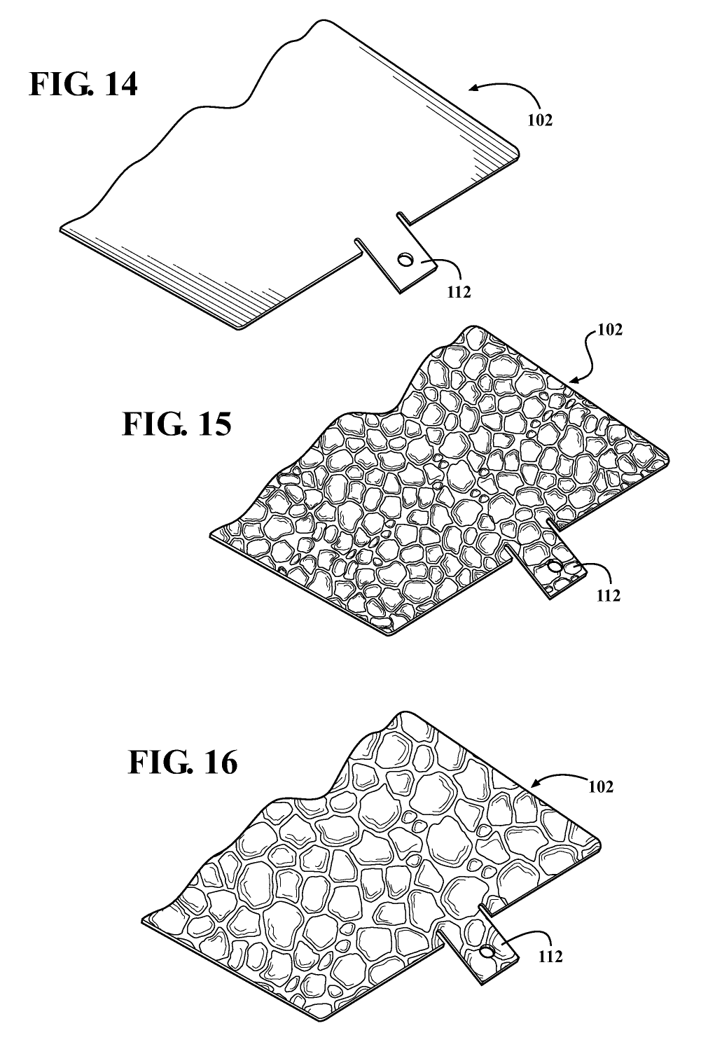

A variety of finishing treatments may be applied to the surface of the first 60 and second 88 reflectors. Varying sized dimples may be applied to the surface to achieve the desired light output of the lighting assembly 20. This dimpling may be referred to as hammer-tone finishing as best illustrated in FIGS. 15 and 16. In one embodiment, the dimpling has a diameter of ½ inch or less. In other embodiment, the dimpling has a diameter of ⅜ inch or less, or even ¼ inch or less. Alternatively, the surface can be left smooth resulting in a mirror-like finish as shown in FIG. 14. The first 60 and second 88 reflectors may have similar or different types of finishing treatments depending on the application of the lighting assembly 20. It is to be appreciated that any other appropriate finishing treatments may be applied to the first 60 and second 88 reflectors without deviating from the subject invention.

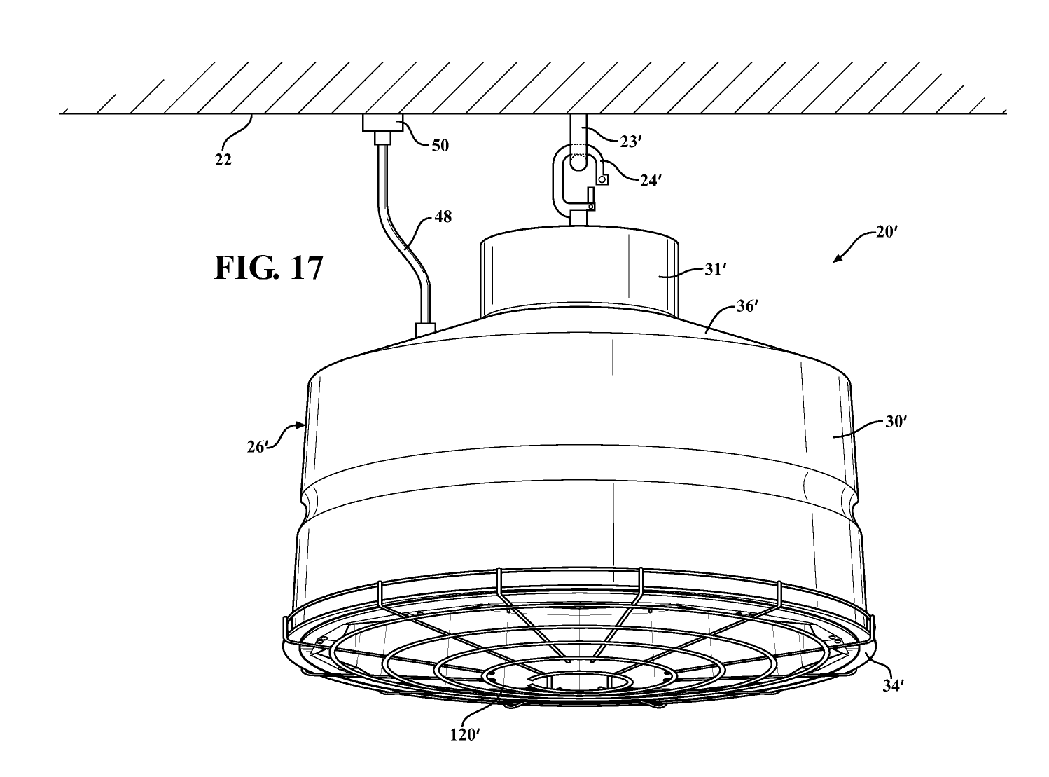

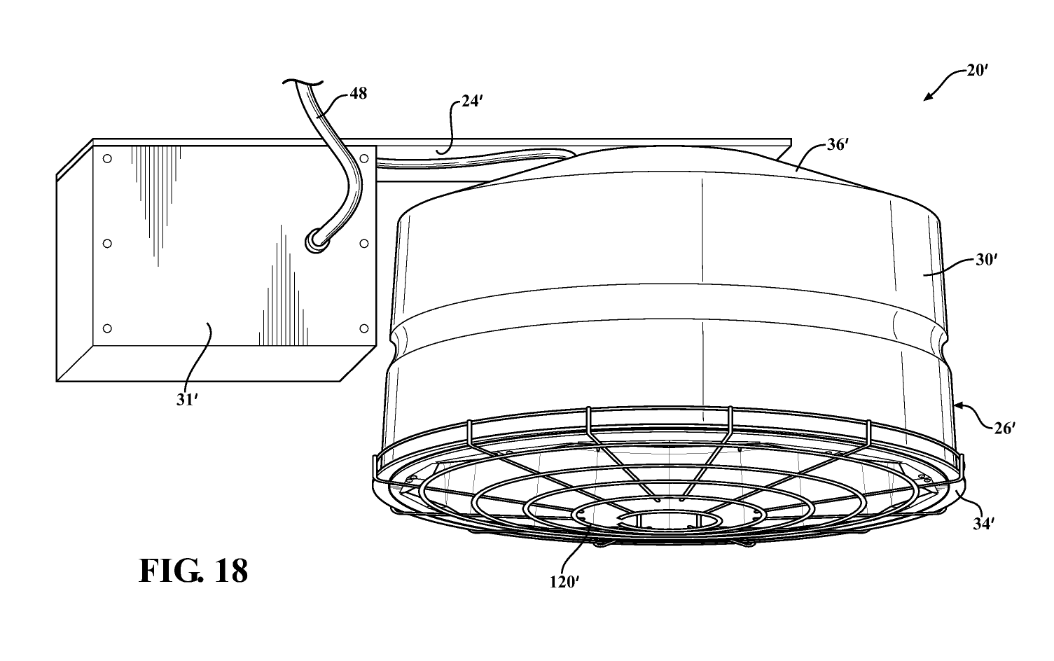

In alternative embodiments, and as mentioned above, the lighting assembly 20 may be further defined as direct-light assembly as shown in FIGS. 17 and 18. In other words, the lighting assembly 20 may be directed toward the floor below the lighting assembly, rather than toward the ceiling 22, as discussed above. As such, like or corresponding parts from one embodiment are accompanied by prime symbols in subsequent embodiments to indicate modification to those like or corresponding parts between the various embodiments. The housing 26 may define alternative configurations throughout the various embodiments. For example, the housing 26 may define a rectangular shape, a triangular shape, a hexagonal shape, a polygonal shape, etc., without deviating from the scope of the present disclosure.

With reference to FIG. 17, the lighting assembly 20′ may include a housing 26′ comprising a continuous side wall 30′ and an end wall 36′ coupled thereto. A casing 31′ may extend from the end wall 36′ and define a secondary cavity (not shown). In other words, the casing 31′ is generally empty and may be configured to receive other components, such as the ballast 46 or a dimmer assembly. The ballast 46 may be disposed within the casing 31′ for concealing the ballast 46 and making the lighting assembly 20′ more aesthetically pleasing. An attachment mechanism 24′ may be coupled to the lighting assembly 20′ for coupling to the ceiling 22. In FIG. 17, the attachment mechanism 24′ is coupled to the casing 31′. The attachment mechanism 24′ may be a hook configured to mate with a complementary mechanism 23′ extending from the ceiling 22 for coupling the lighting assembly 20′ to the ceiling 22. The complementary mechanism 23′ may be another hook, an eyelet, or any other device that will mate with the attachment mechanism 24′ for coupling the lighting assembly 20′ to the ceiling 22. In this embodiment, the power cable 48 may extend from the end wall 36′ for coupling the lighting assembly 20′ to the electric power source 50. Alternatively, the power cable 48 may extend from the casing 31′ without deviating from the scope of the present disclosure.

In another embodiment, as shown in FIG. 18, the lighting assembly 20′ may include the housing 26′. The casing 31′ for enclosing the ballast 46 may be disposed outside and spaced from the housing 26′. In other words, the casing 31′ is not in contact with the housing 26′. The attachment mechanism 24′ may couple the casing 31′ to the housing 26′. Specifically, the attachment mechanism 24′ couples the end wall 36′ of the housing 26′ to the casing 31′. The attachment mechanism 24′ may be coupled to the ceiling 22 utilizing and appropriate method, such as bolts or screws. In certain embodiments, the attachment mechanism 24′ may be coupled to the ceiling 22 via cables disposed between the attachment mechanism 24′ and the ceiling 22. The attachment mechanism 24′ may be further defined as a flat plate. However, it is to be appreciated that the attachment mechanism 24′ may define other configurations without deviating from the subject invention. The power cable 48 typically extends from the ballast 46 and through the casing 31′ for coupling the lighting assembly 20′ to the electrical source 50.

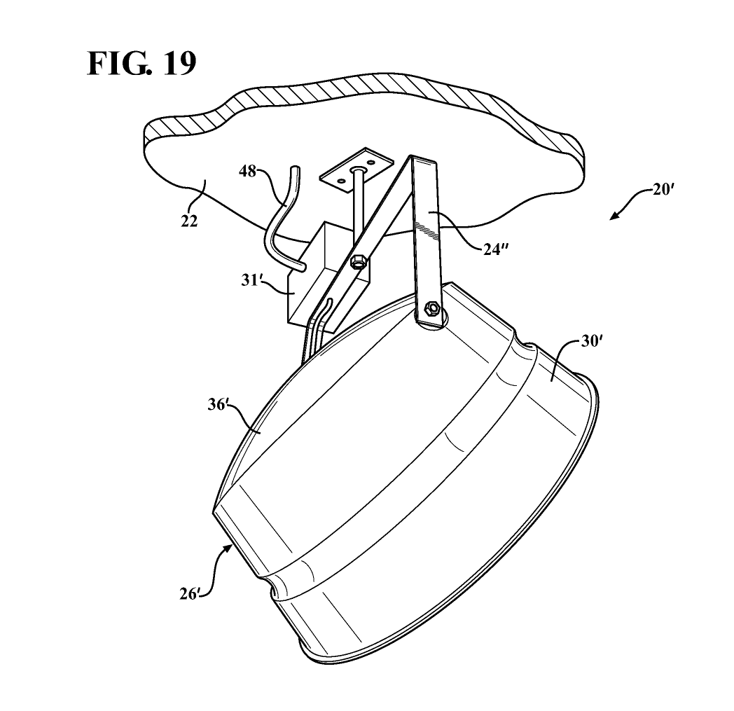

With reference to FIG. 19, another embodiment of the lighting assembly 20′ is shown. Again, the lighting assembly 20′ includes the housing 26′ having the continuous side wall 30′ with the end wall 36′ coupled thereto. The lighting assembly 20′ may also include the attachment mechanism 24″ configured to allow the housing 26′ to move in various directions. Specifically, the attachment mechanism 24″ includes a generally U-shaped portion which couples to the continuous side wall 30′. The housing 26′ is pivotably coupled to the attachment mechanism 24″ such that the housing 26′ may pivot within the U-shaped portion between various angles relative to the attachment mechanism 24″ for positioning the lighting assembly 20′. The attachment mechanism 24″ further includes a connection rod disposed between the U-shaped portion and the ceiling 22 for coupling the lighting assembly 20′ to the ceiling 22 and allowing the housing 30′ to pivot relative to the ceiling 22 and allow for additional positioning of the lighting assembly 20′. The present embodiment is advantageous because the lighting assembly 20′ may be moved to an almost infinite number of positions and allow for ideal lighting conditions for a given event or need. Additionally, because the housing 30′ may pivot within the U-shaped portion, the lighting assembly 20′ may function as both an indirect-light assembly and as a direct-light assembly. The casing 31′ may be coupled to the attachment mechanism 24″ and is spaced from the housing 26′ for enclosing the ballast 46 therein. This type of configuration is typically referred to as a remote ballast in the art. The remote ballast may be coupled to the lighting assembly 20, 20′ as illustrated, or may be spaced from the lighting assembly 20, 20′. The remote ballast may also be spaced from the lighting assembly of from about a few inches to about 33 feet from the lighting assembly 20, 20′. In certain embodiments, the remote ballast may be spaced up to about 300 feet from the lighting assembly 20, 20′. It is to be appreciated that the primary difference of the various embodiments illustrated in FIGS. 17-19 is the attachment mechanism 24 employed.

Although coupling to the ceiling 22 is referenced throughout the present specification, it is to be appreciated that the lighting assembly 20, 20′, specifically the mounting of the lighting assembly 20, 20′, is not so limited. The lighting assembly 20, 20′ may also be coupled to a wall, a beam, a pole, or any other mounting structure without deviating from the scope of the present disclosure.

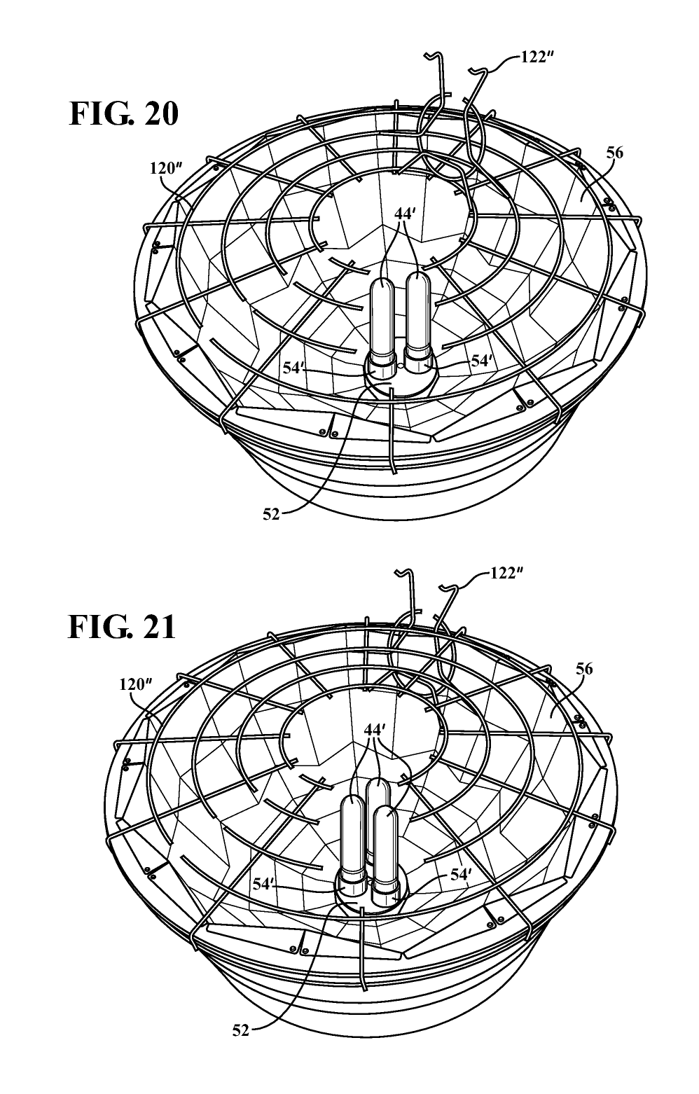

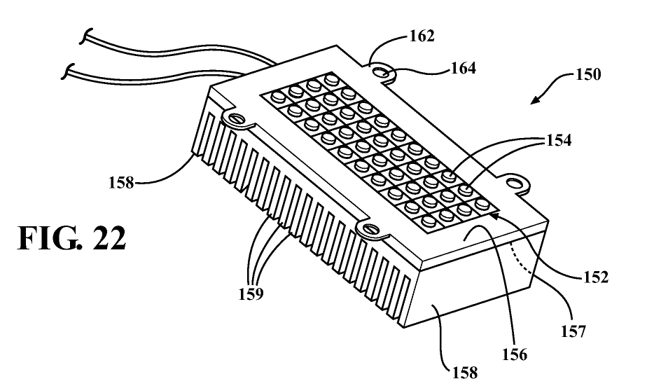

Referring to FIGS. 17 and 18, the screen 120′ may be configured to fit over the housing 26′. In other words, the screen 120′ may extend past the top wall 34′ and be retained over the reflective body 56 though a snap fit with the housing 26′, such that a portion of the screen 120′ abuts the side wall 30′. Again, any appropriate fastener may also be used to couple the screen 120′ to the housing 26′, in addition to or in place of the snap fit. Typically, the screen 120, 120′ must be removed to access the light source 44. However, with reference to FIGS. 20 and 21, the screen 120″ may further include a door 122″. The door 122″ allows for access to the light source 44 and the reflective body 56 without having to remove the screen 120″ from the housing 26′. It is to be appreciated that any embodiment of the screen 120, 120′, 120″ may include the door 122″ without deviating from the scope of the present invention. The various embodiments of the screen 120, 120′, and 120″, as well as variations thereof, may be utilized with any lighting assembly 20, 20′ described above including alternative embodiments not specifically described above.

With continued reference to FIGS. 20 and 21, the lamp stand 52 may include a plurality of sockets 54′. It is to be appreciated that the number of sockets 54′ coupled to the lamp stand 52 is not limited and may include any number of sockets 54′ without deviating from the scope of the present disclosure. It is also to be appreciated that the lamp stand 52 may be further defined as a plurality of lamp stands 52 and that any number of sockets 54′ may be coupled to any number of lamp stands 52 without deviating from the scope of the present disclosure. As such, the light source 44 may be further defined as a plurality of light sources 44′. Typically, the number of light sources 44′ required for the lighting assembly 20, 20′ dictates the number of sockets 54′ coupled to the lamp stand 52. However, it is to be appreciated that more sockets 54′ may be coupled to the lamp stand 52 than the number of light sources 44′ required for a particular lighting assembly 20, 20′ without deviating from the scope of the present disclosure.

In certain embodiments, the lighting assembly 20, 20′ may further include a dimming apparatus (not shown) coupled to the electrical system 42 for allowing each light source 44 to be dimmed. The dimming apparatus is well known to those in the lighting arts may be incorporated into the lighting assembly 20, 20′ for dimming the light output from the light source 44 within the lighting assembly 20, 20′. Each light source 44 may be dimmed of from about 100% light output to about 1% light output, more typically from about 100% light output to about 25% light output, and most typically from about 100% light output to about 50% light output. Dimming is desirable because it will help extend the life of each light source 44 as well as save energy and costs associated therewith. Additionally, dimming each light source 44 allows the lighting assembly 20, 20′ to remain on in a low output setting for extended periods of time and only consume a relatively small amount of electricity. Remaining on at the low output setting is advantageous because it allows the lighting assembly 20, 20′ to be utilized instantly when it is needed and eliminates extended “warm-up” periods before the lighting assembly 20, 20′ is outputting light at a usable level. These “warm-up” periods are a common downfall of lighting assemblies presently available on the market and may take up to ten minutes or more when the lighting assembly is switched to an on setting.

Each light source 44 may be further defined as high-efficiency light sources. Suitable examples of high-efficiency light sources are commercially available under the trade name T-9 lamps and T-12 lamps from Philips Lighting U.S. of Somerset, N.J.

Combining the subject housing 26, 26′ and reflective body 56 with these high-efficiency light sources 44′ increases the light output of each lighting assembly 20, 20′. Specifically, the high-efficiency light sources 44′ combined with the subject reflective body 56 outputs up to 40% more light than a standard metal-halide light source. For example, the standard metal-halide light source utilized in this type of application will consume about 1000 W, while an exemplary lighting assembly 20, 20′ of the present disclosure may utilize two 315 W high-efficiency light sources 44, in sum consuming approximately 630 W. Obviously, less Watts are consumed by the lighting assembly 20, 20′ of the present disclosure. However, up to 40% more light is output from the lighting assembly 20, 20′ of the present disclosure, while using less energy.

As one example of the improvement of the subject invention and without intending to be limiting, in a recent analysis significant cost savings were realized. Without accounting for the additional light output and merely focusing on the energy savings, approximately 370 W of energy may be saved per unit, i.e. 1000 W−630 W=370 W. Electricity consumption is typically measured in kilowatt hours. Simply put, a kilowatt hour (kWh) is a measurement of how many kilowatts of energy are consumed in one hour. The analysis examined how much cost savings will be realized per lighting assembly in a year. Assuming each lighting assembly 20, 20′ will be turned on every day (365 days) for 18 hours per day, each lighting assembly 20, 20′ will be on for about 6570 hours per year. Since there are 1000 W in 1 kW, each lighting assembly 20, 20′ will save about 0.370 kW over lighting assemblies generally known in the art. Therefore, each lighting assembly 20, 20′ of the present disclosure will save about 2431 kWh over a year of use. Currently, electricity is billed at about fourteen (14) cents per kWh. As such, each lighting assembly will save about $340 per year. If a facility utilizes 1000 lighting assemblies 20, 20′, that facility will save over $340,000 per year in energy costs. Additionally, as a result of the additional light output, the facility may reduce the total number of lighting assemblies utilized, further reducing the energy costs incurred by the facility.

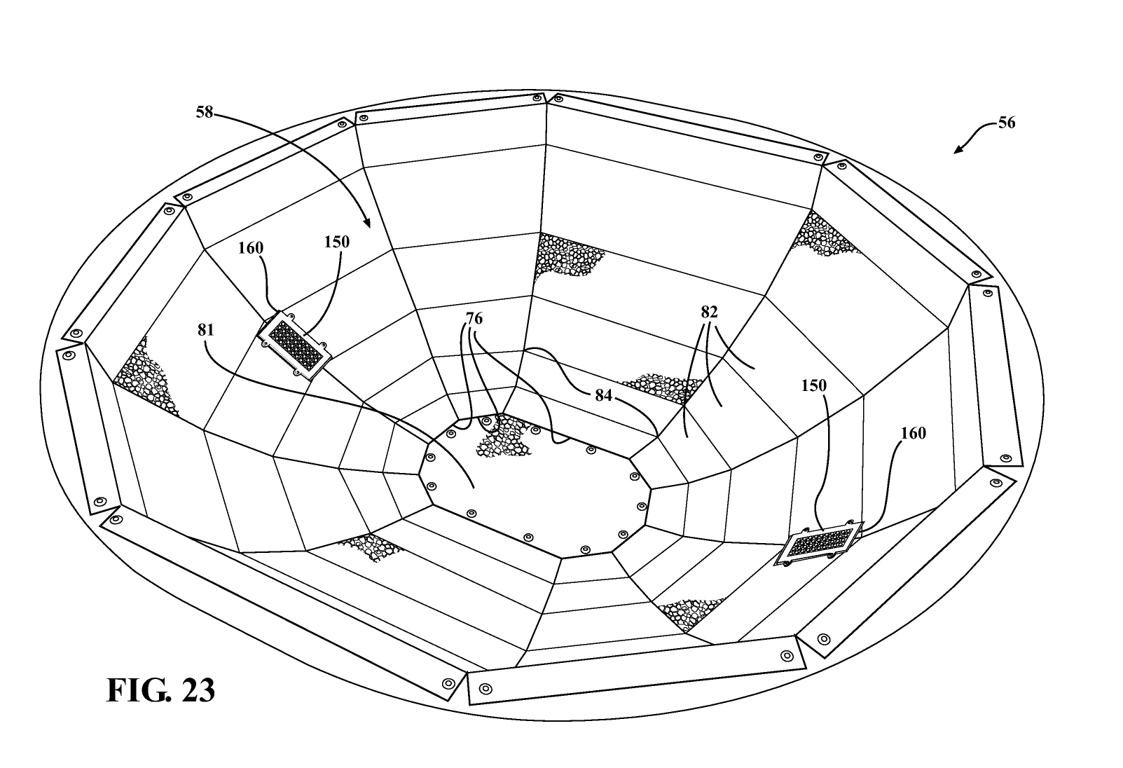

In accordance with yet another embodiment, FIGS. 22-33 illustrate the lighting assembly 20 utilizing an LED (light emitting diode) assembly 150 as a source of light. As shown in FIG. 22, the LED assembly 150 includes an LED array 152 that includes at least one LED 154. Typically, the LED array 152 includes a plurality of LEDs 154. The lighting assembly 20 utilizing the LED assembly 20 is generally utilized as a direct-light assembly. However, the lighting assembly 20 may alternatively be utilized as an indirect-light assembly.

In one embodiment as shown in FIG. 22-23, the LED array 152 has a substantially planar configuration. Alternatively, the LED array 152 may have a non-planar configuration, such as a curved configuration, and the like.

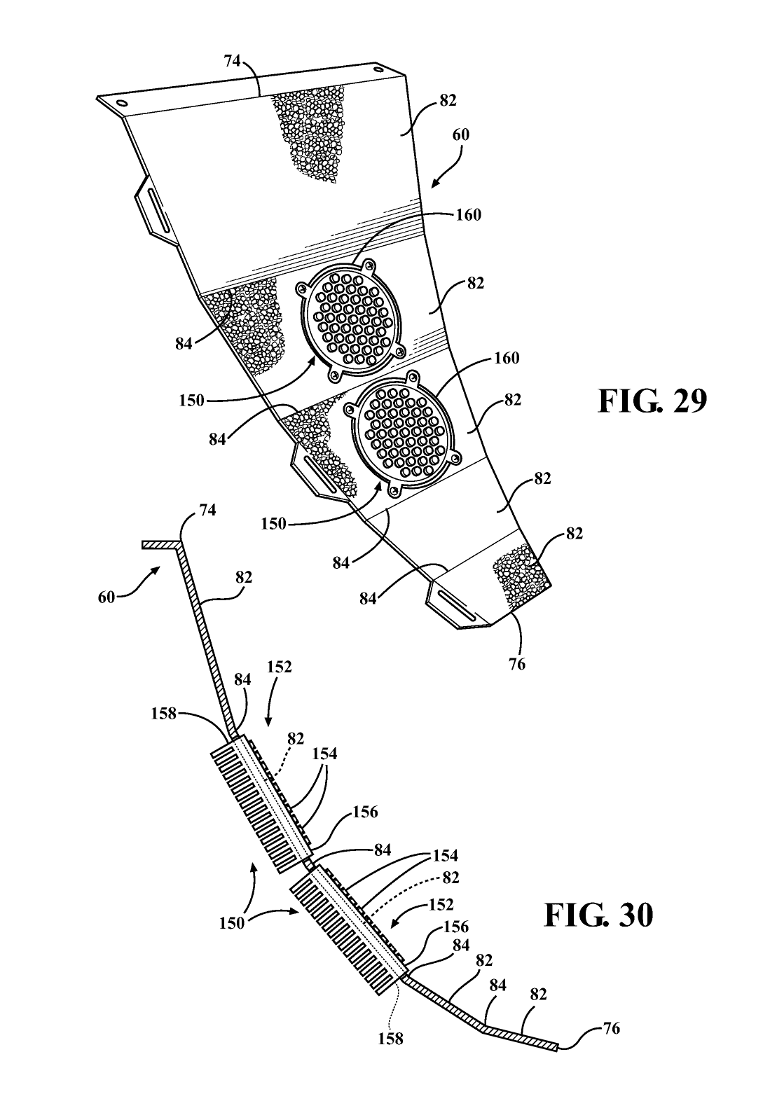

The LED array 152 may also have various geometric configurations. In FIG. 22, the LED array 152 has a rectangular configuration with the LEDs 154 arranged in rows and columns In one embodiment, the LED array 152 includes twice as many rows as columns. For example, as shown in FIG. 22, the LED array 152 includes four rows and ten columns such that forty LEDs 154 are in the LED array 152. However, the LED array 152 may include any suitable number of rows and columns. The LED array 152 may have other geometrical configurations, such as a circular configuration as shown in FIG. 29, a single-line configuration, and the like. The lighting assembly 20 may also utilize a plurality of LED assemblies 150, as will be described in detail below.

As best shown in FIG. 22, the LED assembly 150 may include a front face 156 having a substantially planar configuration. The LED array 152 is disposed on the front face 156. As shown in FIGS. 23-33, the front face 156 is typically arranged to face an interior of the reflective body 56.

The LED assembly 150 includes a rear face 157 opposite the front face 156. In one embodiment, the rear face 157 includes a substantially planar configuration. As shown in FIGS. 23-33, the rear face 157 is typically arranged to face an exterior of the reflective body 56. However, portions of the rear face 157 may face an interior of the reflective body 56 while portions of the rear face 157 may face an interior of the reflective body 56, as shown in FIG. 30.

The LED assembly 150 may include a cooling device for managing heat emitted from the LED assembly 150. In one embodiment, as shown in FIGS. 22, 28, 30 and 32, the cooling device is a hint sink 158 for absorbing the heat emitted by the LED assembly 150. The heat sink 158 may have any suitable number of fins 159 and include any suitable thermal resistance for cooling the LED assembly 150. In FIG. 22, the heat sink 158 is disposed on the rear face 157 of the LED assembly 150. The cooling device may have other configurations. For example, the cooling device may include a fan system, a heat exchanging thermal compound, a liquid cooling apparatus, and the like.

As shown throughout, at least two of the first reflectors 60 each define an opening 160. As will be described in detail below, each one of the LED assemblies 150 is disposed adjacent to one of the openings 160. As such, the openings 160 allow light emitted from the LED assemblies 150 to enter the interior of the reflective body 56.

Each opening 160 is defined between the lower end 76 and upper end 74 of the first reflector 60. More specifically, each opening 160 is defined by at least one planar surface 82 of the first reflector 60. By being defined between the lower end 76 and upper end 74, the openings 160 distinguished from the hole 80 collectively defined the lower ends 76 of the first reflectors 60 through which a light source 44 is placed, as shown in FIGS. 3 and 12. Similarly, the openings 160 are distinguished from the reflective body 56 opening collectively defined by the upper ends 74 of the first reflectors 60 through which the light from the reflective body 56 is collectively emitted.

In one embodiment as shown in FIG. 29, the opening 160 may be defined within one planar surface 82 such that the opening 160 is bound between two horizontal bends 84. In other words, the opening 160 does not extend beyond the horizontal bends 84.

Alternatively, as shown in FIGS. 23-27 and 31 the opening 160 may be defined across two or more adjacent planar surfaces 82. In such instances, the opening 160 extends across at least one horizontal bend 84. In some instances, the opening 160 may extend across more than one horizontal bend 84 such that the opening 160 is defined across three or more adjacent planar surfaces 82.

In another embodiment as shown in FIG. 23, the opening 160 extends across at least two adjacent first reflectors 60. In such instances, the opening 160 extends across at least the first side 62 of one first reflector 60 and the second side 64 of the adjacent first reflector 60. The opening 160 may extend across more than two adjacent first reflectors 60.

In FIG. 29, at least one of the first reflectors 60 includes a plurality of openings 160. In such instances, each of the openings 160 is defined between the lower and upper ends, 76, 74 of the same first reflector 60. The plurality of openings 160 may be defined on the first reflector 60 according to any configuration described herein.

The openings 160 may be defined at various locations on the reflective body 56. Generally, the openings 160 are defined circumferentially about the central axis C. In one embodiment as shown in FIGS. 23-26, the openings 160 are defined at substantially similar locations with respect to the first reflectors 60. For example, each opening 160 may be defined at similar planar surfaces 82 of the first reflectors 60. Alternatively, the openings 160 may be defined at different planar surfaces 82 of the first reflectors 60.

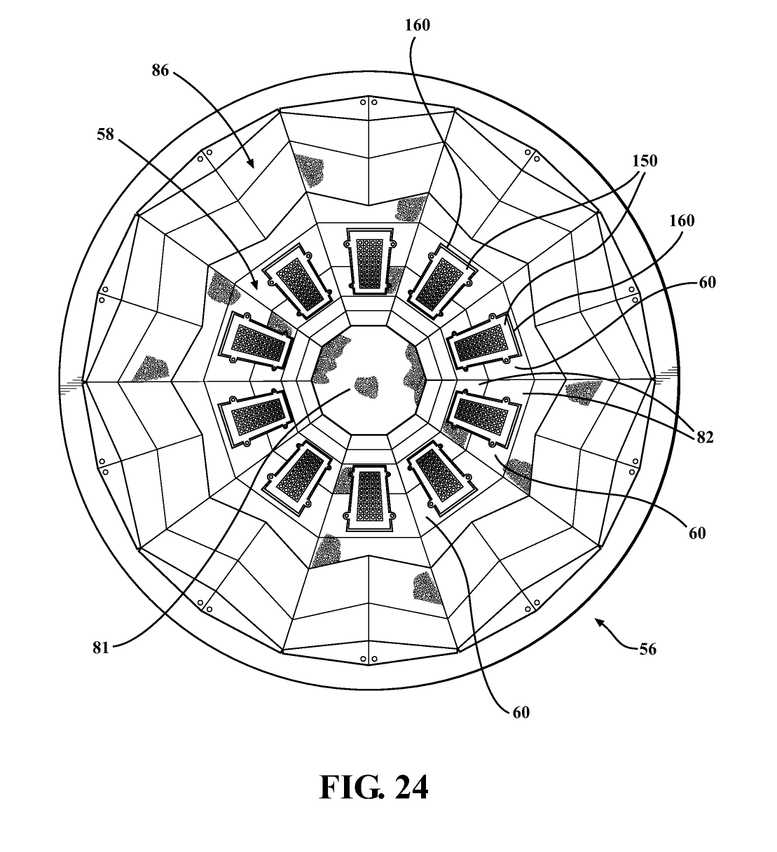

The openings 160 may be defined in various configurations with respect to one another. In one example, as shown in FIGS. 23 and 24, the openings 160 are defined at first reflectors 60 that are symmetrically positioned with respect to one another. Alternatively, the openings 160 may be defined at first reflectors 60 that are asymmetrically positioned with respect to one another.

The openings 160 may be formed according to any suitable method. In one embodiment, the reflective body 56 is cast into form with the openings 160. Alternatively, the openings 160 may be mechanically formed into the reflective body 56 by any suitable process, such as stamping, cutting, and the like.

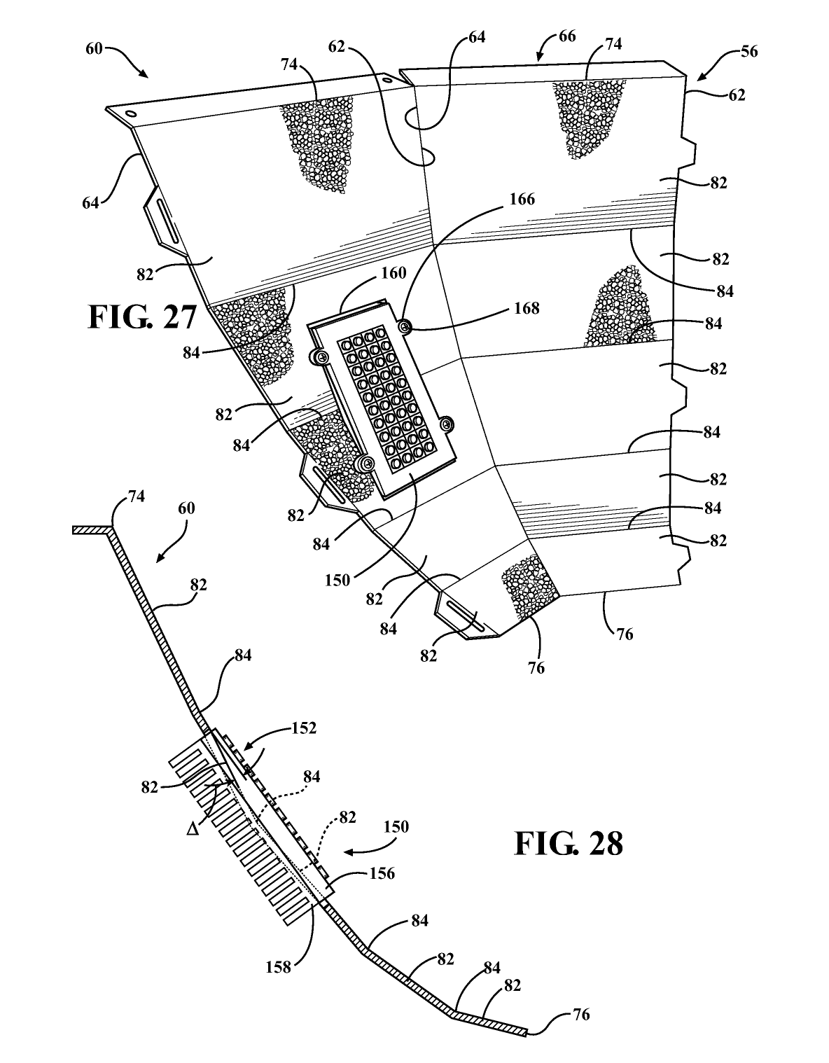

The openings 160 may have any suitable geometric configuration. Generally, the opening 160 has a geometric configuration to suitably accommodate the LED assembly 150 and the LED array 152. In one embodiment, as best shown in FIG. 27, the opening 160 has a rectangular configuration to accommodate the rectangular configuration of the LED array 152. Alternatively, the opening 160 may have other geometric configurations, such as a circular configuration as shown in FIG. 29, and the like. The openings 160 may all have the same geometric configuration. Alternatively, openings 160 may have different geometric configurations.

As described, each one of the LED assemblies 150 is disposed adjacent to one of the openings 160. Generally, the LED assemblies 150 are circumferentially disposed about the central axis C. The lighting assembly 20 may include any suitable number of LED assemblies 150. In one example, the number of LED assemblies 150 may depend on the number of first reflectors 60 in the reflective body 56. As shown in FIG. 24, the lighting assembly 20 may include one LED assembly 150 for each first reflector 60. For example, if the first array 58 includes ten first reflectors 60, the lighting assembly 20 may include ten LED assemblies 150 each disposed adjacent an opening 160 on each first reflector 60.

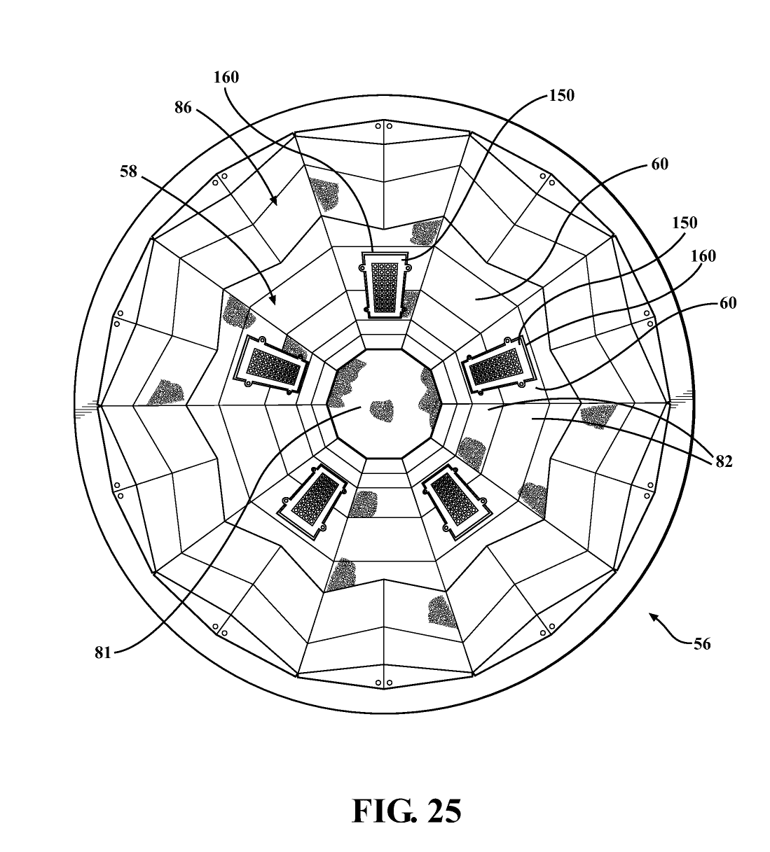

Alternatively, as shown in FIG. 27, at least one first reflector 60 may include the LED assembly 150 disposed adjacent the opening 160 while a next adjacent first reflector 60 does not include an LED assembly disposed 160 adjacent the opening 160. In more specific embodiments, as shown in FIG. 25, the lighting assembly 20 may include one LED assembly 150 disposed adjacent an opening 160 on every other first reflector 60. For example, if the first array 58 includes ten first reflectors 60, the lighting assembly 20 may include five LED assemblies 150 each disposed adjacent an opening 160 on every other first reflector 60.

Additionally, the reflective body 56 may have the same number of openings 160 as LED assemblies 150. Alternatively, the reflective body 56 may include more openings 160 than LED assemblies 150 such that some openings 160 do not have an LED assembly 150 disposed adjacent thereto.

In FIG. 29, the LED assembly 150 is disposed adjacent the opening 160 defined within one planar surface 82 such that the LED assembly 150 is bound between two horizontal bends 84. In such instances, the planar configuration of the LED array 152 is disposed parallel with respect to the planar surface 82, as shown in FIG. 30. In some instances, the planar configuration of the LED array 152 may be parallel and coplanar with the planar surface 82. In other instances, the planar configuration of the LED array 152 may be parallel to, but non-coplanar with, the planar surface 82. In other words, the LED array 152 may be parallel to, but disposed above or below, the planar surface 82.

In another embodiment, as shown in FIGS. 23-28, the LED assembly 150 is disposed adjacent the opening 160 defined across two or more adjacent planar surfaces 82. In doing so, the LED assembly 150 extends across at least one horizontal bend 84. In such instances, the planar configuration of the LED array 152 is disposed at a predetermined angle with respect the planar surfaces 82, as shown in FIG. 28. In FIG. 28, the predetermined angle is identified by the symbol “Δ” and is defined between the planar surfaces 82 and the planar configuration of the LED array 152. In FIG. 28, the predetermined angle Δ is minimal because the planar configuration of the LED array 152 is substantially co-planar and parallel, or flush, with the planar surfaces 82. In other words, the planar configuration of the LED array 152 does not protrude substantially from the interior face of the first reflector 60. In one embodiment, the predetermined angle Δ is defined in a range between 0 and 25 degrees. In another embodiment, the predetermined angle Δ is defined in a range between 0 and 5 degrees.

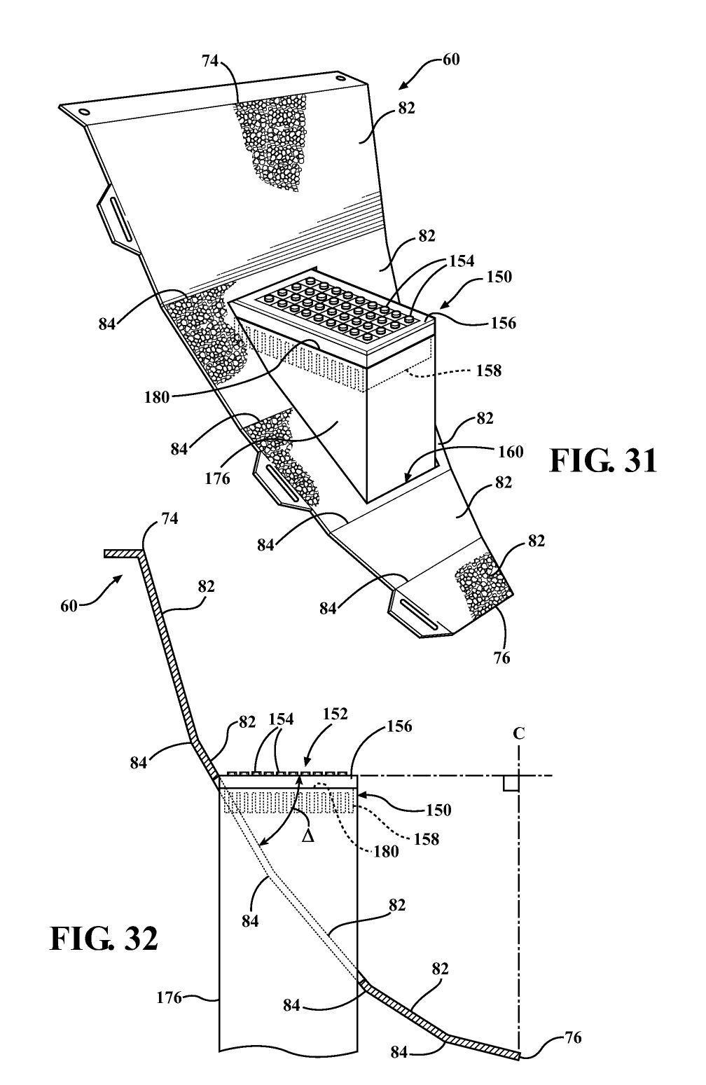

In yet another embodiment, as shown in FIGS. 31 and 32, the LED array 152 is disposed substantially horizontally such that the LED array 152 is disposed on a plane that is substantially perpendicular to the central axis C. As such, the LED array 152 and the planar surfaces 82 are disposed transverse one another. In other words, the LED array 152 and the planar surfaces 82 are non-parallel. In such instances, the LED array 152 and the planar surface 82 are disposed non-coplanar with one another. In instances when the LED array 152 is disposed horizontally, the LED array 152 may be disposed according to various configurations with respect to the reflective body 56. For example, the LED array 152 may be partially disposed within the interior of the reflective body 56 and partially disposed outside the reflective body 56. Alternatively, the LED array 152 may be disposed entirely within the interior of the reflective body 56.

In FIG. 32, the planar configuration of the LED array 152 is disposed at a predetermined angle with respect the planar surfaces 82. The predetermined angle Δ in FIG. 32 is defined between the planar surfaces 82 and the planar configuration of the LED array 152. In FIG. 32, the predetermined angle Δ is relatively large because the planar configuration of the LED array 152 is substantially transverse with the planar surfaces 82. In other words, the planar configuration of the LED array 152 protrudes substantially from the interior face of the first reflector 60. In one embodiment, the predetermined angle Δ is defined in a range between 45 and 90 degrees. In another embodiment, the predetermined angle Δ is defined in a range between 25 and 45 degrees.

In FIG. 23, the LED assembly 150 is disposed adjacent the opening 160 that extends across at least two adjacent first reflectors 60 in the array. In such instances, the LED array 152 extends across at least the first side 62 of one first reflector 60 and the second side 64 of the adjacent first reflector 60. In FIG. 23, the planar configuration of the LED array 152 may be transverse or flush to the planar surfaces 82 of the adjacent first reflectors 60.

In FIG. 29, at least one of the first reflectors 60 includes a plurality of LED assemblies 150. The first reflector 60 includes a plurality of openings 160 with each LED assembly 150 disposed adjacent one of the openings 160.

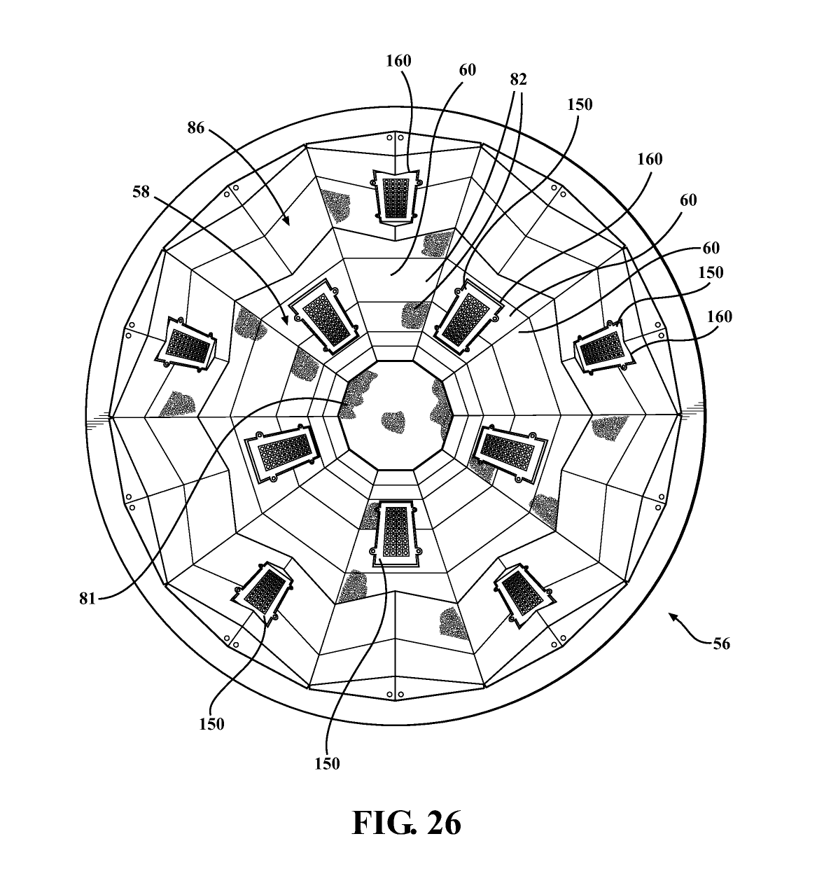

In yet another embodiment, as shown in FIG. 26, at least one of the reflectors 88 of the second array 86 includes the opening 160 with the LED assembly 150 disposed adjacent the opening 160. In one instance, the LED assembly 150 is disposed adjacent an opening 160 defined across the vertex 96 of the second reflector 88. In another instance, the LED assembly 150 is disposed adjacent an opening 160 defined within the right face 92 of the second reflector 88. Alternatively, the LED assembly 150 is disposed adjacent an opening 160 defined within the left face 90 of the second reflector 88. With respect to the reflectors 88 of the second array 86, the openings 160 and the LED assemblies 150 may have any other configuration or arrangement as described herein with respect to the first reflectors 60.

The LED assembly 150 generally occupies a majority or an entirety of the opening 160. As such, exposure of the interior of the reflective body 56 to environmental elements is minimized. Furthermore, having the LED assembly 150 occupy the majority or the entirety of the opening 160 maximizes the reflective surface area of the reflective body 56.

In one embodiment, as shown in FIGS. 27 and 29, the LED assembly 150 is coupled directly to the reflective body 56. The LED assembly 150 may couple to the reflective body 56 according to various configurations. In one configuration, the LED assembly 150 is fastened to the reflective body 56. As shown in FIG. 22, the LED assembly may include at least one bracket 162. The bracket 162 may extend from the front face 156 of the LED assembly 150. The bracket 162 is generally placed against the interior or the exterior surface of the reflective body 56, as shown in FIGS. 27 and 29. The bracket 162 includes a hole 164 defined therein. The hole 164 is configured to receive a fastener 166, such as a bolt or screw. As the fastener 166 is tightened to the bracket 162, the reflective body 56 is secured between the fastener 166 and the bracket 162. In one embodiment, a washer 168 is disposed about the fastener 166 and the reflective body 56 is secured between the washer 168 and the bracket 162.

Alternatively, as shown in FIG. 33, the LED assembly 150 may be coupled to the housing 26. One embodiment of the housing 26 utilized in conjunction with the LED assemblies 150 is illustrated in FIG. 33. The housing 26 is hollow and defines a first portion 172 defining a conical configuration and a second portion 174 having a cylindrical configuration. Of course, the housing 26 utilized in conjunction with the LED assemblies 150 may have various other configurations without departing from the scope of the invention. Moreover, the housing 26 utilized in conjunction with the LED assemblies 150 may have features of the other embodiments of the housing 26 described herein.

In one embodiment, the LED assembly 150 is coupled directly to the housing 26. For example, the LED assembly 150 may be coupled directly to the conical first portion 172 of the housing 26. The LED assembly 150 may be coupled to the first portion 172 according to any suitable method. In one example, the rear face 157 of the LED assembly 150 is fastened directly to the first portion 172. In another example, the heat sink 158 may be fastened to the first portion 172.

Alternatively, as shown in FIGS. 31-33, the housing 26 may include a support member 176 extending from the housing 26 for supporting the LED assembly 150. The support member 176 may include a proximal end 178 and a distal end 180 opposite the proximal end 178. The proximal end 178 is coupled to the housing 26, and more specifically, the second portion 172. The distal end 180 is coupled to the LED assembly 150. The support member 176 may have any suitable length for positioning the LED assembly 150 adjacent the opening 160. The support member 176 may be integrally formed as part of the housing 26 or may be a separate component attached to the housing 26. The support member 176 may have any suitable configuration, including, but not limited to, a circular cross-section, a rectangular cross-section, and the like. Additionally, the support member 176 may be hollow or solid. In instances where the support member 176 is hollow, the heat sink 158 may be disposed within and/or coupled to the support member 176.

As described above, the LED assemblies 150 generate heat during operation. Although the heat sink 158 provides adequate heat management in most instances, the lighting assembly 20 may require additional heat management because the LED assemblies 150 are disposed adjacent the reflective body 56. In one embodiment, the support member 176 may be formed of a heat absorbing material for dissipating heat from the LED assembly 150. In such instances, the support member 176 may act as a heat sink. According to another embodiment, the first reflectors 60 and second reflectors 88 may be formed of a heat absorbing material for effectively absorbing and/or dissipating heat from the LED assemblies 150. In one instance, the first reflectors 60 and second reflectors 88 are formed of a predetermined material for absorbing heat. The material may have any suitable heat absorbing properties, such as thermal resistance, and the like.

In one embodiment, the first reflectors 60 are formed or cast as a single integral unit to most effectively absorb heat from the LED assemblies 150. In another embodiment, the first reflectors 60 and second reflectors 88 are formed or cast as a single integral unit to most effectively absorb heat from the LED assemblies 150

The present invention has been described in an illustrative manner, and it is to be understood that the terminology which as been used in intended to be in the nature of words of description rather than of limitation. Obviously, many modifications and variations of the present invention are possible in light of the above teachings. The invention may be practiced otherwise than as specifically described within the scope of the appended claims.

What is claimed is:

1. A lighting assembly for illuminating an area, said lighting assembly comprising:
a reflective body comprising;
a first array of reflectors disposed about a central axis with said reflectors collectively forming a dome-shaped configuration,
each of said reflectors defining a lower end and an opposing upper end and comprising a plurality of planar surfaces defined between said lower end and said upper end and being separated from one another by discrete horizontal bends, with said planar surfaces collectively forming an arcuate configuration between said lower end and said upper end, wherein at least two reflectors each define an opening between said lower and upper ends, and
an LED assembly disposed adjacent each one of said openings such that said reflective body reflects light emitted from said LED assemblies.

2. The lighting assembly of claim 1 wherein at least one of said LED assemblies includes an LED array having a substantially planar configuration.

3. The lighting assembly of claim 2 wherein said LED array is disposed substantially parallel to one of said planar surfaces.

4. The lighting assembly of claim 2 wherein said LED array is disposed at a predetermined angle to one of said planar surfaces such that said LED array and said planar surface are disposed transverse one another.

5. The lighting assembly of claim 1 wherein at least one of said LED assemblies is disposed across two adjacent planar surfaces.

6. The lighting assembly of claim 1 wherein at least one of said LED assemblies is disposed across two adjacent reflectors.

7. The lighting assembly of claim 1 wherein two adjacent reflectors each include one of said LED assemblies disposed adjacent said opening.

8. The lighting assembly of claim 1 wherein at least one reflector includes said LED assembly disposed adjacent said opening while said next adjacent reflector does not include said LED assembly disposed adjacent said opening.

9. The lighting assembly of claim 1 wherein one of said reflectors includes a plurality of said LED assemblies with each LED assembly disposed adjacent one of said openings.

10. The lighting assembly of claim 1 wherein said LED assemblies are disposed circumferentially about said central axis.

11. The lighting assembly of claim 1 wherein said LED array has a substantially rectangular configuration.

12. The lighting assembly of claim 1 including a second array of reflectors disposed about said central axis with each of said reflectors of said second array comprising a left face and a right face with a reflex angle defined by said left face and said right face.

13. The lighting assembly of claim 12 wherein at least one of said reflectors of said second array defines an opening with said LED assembly disposed adjacent said opening.

14. The lighting assembly of claim 1 wherein said reflective body is formed of a single integrally formed piece.

15. The lighting assembly of claim 14 wherein said reflective body comprises a heat absorbing material such that said reflective body absorbs heat emitted from said LED assemblies.

16. The lighting assembly of claim 1 wherein at least one of said LED assemblies includes a cooling device for managing heat emitted from said LED assembly.

17. The lighting assembly of claim 1 wherein a hole is defined collectively between said lower ends of said first reflectors, and further including a cap coupled to said lower ends for covering the hole.

18. The lighting assembly of claim 1 including a housing for substantially enclosing said reflective body and said LED assemblies.

19. The lighting assembly of claim 18 wherein at least one LED assembly is coupled directly to said housing.

20. The lighting assembly of claim 1 wherein at least one LED assembly is coupled directly to said reflective body.

21. A lighting assembly for illuminating an area, said lighting assembly comprising:
a reflective body comprising;
a first array of first reflectors disposed about a central axis, each of said first reflectors defining a lower end and an opposing upper end and comprising a plurality of planar surfaces defined between said lower end and said upper end and being separated from one another by discrete horizontal bends and collectively forming an arcuate configuration between said lower end and said upper end,
a second array of second reflectors disposed about said central axis with each of said second reflectors comprising a left face and a right face with a reflex angle defined by said left face and said right face,
said first and second arrays collectively forming a dome-shaped configuration,
at least two of said first reflectors each define an opening between said lower and upper ends, and
an LED assembly disposed adjacent each one of said openings such that said reflective body reflects light emitted from said LED assemblies.
